(19) United States
(12) Patent Application Publication
(10) Pub. No.: US 2005/0025104 A1
(43) Pub. Date: Feb. 3, 2005

(54) Managing coexistence of separate protocols sharing the same communications channel

(76) Inventors: Michael Andrew Fischer, San Antonio, TX (US); Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/830,575

(22) Filed: Apr. 23, 2004

Related U.S. Application Data
(60) Provisional application No. 60/491,172, filed on Jul. 30, 2003.

(51) Int. Cl. H04L 12/28

(52) U.S. Cl. 370/338; 370/464; 370/473

(57) ABSTRACT

A technique is disclosed that provides an improvement in how stations that operate in accordance with different protocols coexist in the same network without some of the costs and disadvantages of the prior art. The illustrative embodiment of the present invention provides protection against collisions due to transmissions in accordance with a first protocol (e.g., IEEE 802.11, etc.) occurring around the same time as transmissions in accordance with a second protocol (e.g., Bluetooth, etc.). Protection against collisions is achieved in the illustrative embodiment by a protecting station causing other stations (e.g., access points, etc.) to defer any pending first protocol transmissions during a predetermined time interval. The protecting station is then able to transmit in accordance with the second protocol during the predetermined time interval.

### CROSS-REFERENCE TO RELATED APPLICATIONS

This application claims the benefit of U.S. provisional application Ser. No. 60/491,172, filed Jul. 30, 2003, entitled “Managing Coexistence of Separate Protocols Sharing the Same Communications Channel,” (Attorney Docket: 680-083us), which is herein incorporated by reference.

### FIELD OF THE INVENTION

The present invention relates to telecommunications in general, and, more particularly, to local area networks (LAN).

### BACKGROUND OF THE INVENTION

FIG. 1 depicts a schematic diagram of wireless local-area network (LAN) 100 in the prior art comprising access point 101, stations 102-1 through 102-K, wherein K is a positive integer, and shared-communications channel 103. Stations 102-1 through 102-K are typically associated with host computers (not shown), such as notebook computers, personal digital assistants (PDA), tablet PCs, etc. Stations 102-1 through 102-K enable communications between (i) the host computers or (ii) the host computers and other devices, such as printer servers, email servers, file servers, etc. Access point 101 enables stations 102-1 through 102-K to (i) coordinate transmissions between each other and (ii) communicate with devices in other communications networks.

Access point 101 and stations 102-k, for k=1 through K, transmit data blocks called “frames” over shared-communications channel 103. If two or more stations (or access point 101 and a station) transmit frames simultaneously, then one or more frames can become corrupted, resulting in what is called a “collision”. Local-area networks, therefore, typically employ a medium access control (MAC) protocol for ensuring that a station can gain exclusive access to shared-communications channel 103 for an interval of time in order to transmit one or more frames. A “protocol” is a set of communications procedures that relate to the format and timing of transmissions between different stations.

In wireless local-area networks that are based on the Institute of Electrical and Electronics Engineers (IEEE) 802.11 standard, the medium access control protocol is based on a mechanism called “carrier sense multiple access” (CSMA), in which station 102-k or access point 101 can detect whether shared-communications channel 103 is busy or idle. If shared-communications channel 103 is busy, station 102-k or access point 101 will wait until the channel is idle before attempting to transmit a signal that conveys a message.

Shared-communications channel 103 can be used by stations that operate in accordance with different protocols. For example, the IEEE 802.11 standard (e.g., 802.11a, 802.11b, 802.11e, 802.11g, etc.) describes one set of protocols, and the Bluetooth standard describes another set of protocols. A particular station (e.g., station 102-1, etc.) might handle an IEEE 802.11 protocol or a Bluetooth protocol, or both. A station that is capable of handling multiple protocols (i.e., a “multi-protocol station”) comprises multiple protocol subsystems, or “parts”, in which each part handles communications in accordance with a specific protocol.

Typically, additional communications procedures need to be implemented to enable multiple protocol parts of a station to share a common communications resource, such as shared-communications channel 103. For example, the IEEE 802.15.2 recommended practices document describes packet traffic arbitration (PTA) as a technique for arbitrating between an IEEE 802.11 part and a Bluetooth part that are attempting to transmit at the same station. Packet traffic arbitration grants one part or the other permission to transmit on a message-by-message basis, to some extent by exchanging transmission requirements between the two parts.

An obstacle in deploying multi-protocol stations is that although packet traffic arbitration governs transmissions within a station, packet traffic arbitration does not provide overall arbitration for wireless local area network 100. Particularly, packet traffic arbitration does not provide arbitration for IEEE 802.11 messages being transmitted by a first station that is unaware of Bluetooth message activity originating at a second station. Consequently, at a moment in time when packet traffic arbitration has granted shared-communications channel 103 to the second station to transmit a Bluetooth signal, the first station might incorrectly determine shared-communications channel 103 to be idle and transmit its own signal over the channel, resulting in a collision.

Therefore, a need exists for an improvement in how stations that operate in accordance with different protocols coexist in the same network without some of the costs and disadvantages in the prior art.

### SUMMARY OF THE INVENTION

The present invention provides a technique for improving how stations that operate in accordance with different protocols coexist in the same network without some of the costs and disadvantages of the prior art. The illustrative embodiment of the present invention provides protection against collisions due to transmissions in accordance with a first protocol (e.g., IEEE 802.11, etc.) that occur concurrently with transmissions in accordance with a second protocol (e.g., Bluetooth, etc.). In accordance with the illustrative embodiment, this is achieved by having a first station transmit a message that causes other stations (e.g., access points, etc.) to defer their transmissions during a specified time interval. The time interval is specified as part of a duration field in the message. The protecting station transmits a frame to itself, in some embodiments, to specify the deferring time interval.

The underlying purpose and importance of the deferral is to allow messages to be transmitted in accordance with the second protocol during the predetermined time interval. As an example, this deferral mechanism can be used to support synchronous connection oriented (SCO) voice operation of one or more Bluetooth stations that are collocated with IEEE 802.11 stations. The synchronous connection oriented operation requires fine granularity timing of the Bluetooth transmissions of each wireless channel, timing that the illustrative embodiment can support.

The illustrative embodiment is disclosed in the context of wireless networks that are governed by IEEE 802.11 and Bluetooth protocols. It will be clear, however, to those skilled in the art how to make and use embodiments of the present invention for networks based on other standards and protocols.

An illustrative embodiment of the present invention comprises: (a) monitoring a shared-communications channel for an opportunity to transmit; and (b) transmitting a first message on the shared-communications channel in accordance with a first protocol, wherein: (i) the first message is addressed to the sender of the first message; and (ii) the first message comprises a duration field that comprises a value that is based on the expected length of time required to transmit at least a second message on the shared-communications channel in accordance with a second protocol.

### BRIEF DISCRIPTION OF THE DRAWINGS

FIG. 1 depicts a schematic diagram of wireless local area network 100 in the prior art.

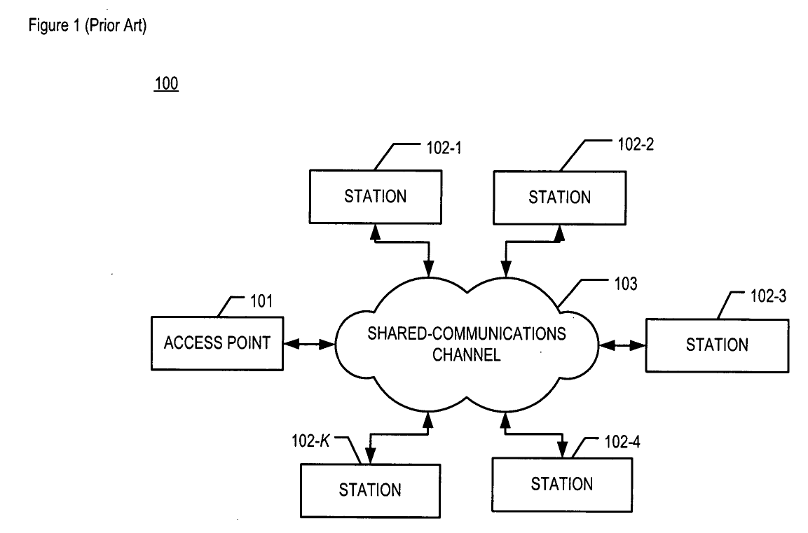

FIG. 2 depicts a schematic diagram of a portion of network 200 in accordance with the illustrative embodiment of the present invention.

FIG. 3 depicts a block diagram of the salient components of access point 201 in accordance with the illustrative embodiment of the present invention.

FIG. 4 depicts a block diagram of the salient components of multi-protocol station 203-i in accordance with the illustrative embodiment of the present invention.

FIG. 5 depicts a flowchart of the salient tasks performed in accordance with the illustrative embodiment of the present invention.

FIG. 6 depicts a sequence of messages exchanged in accordance with the illustrative embodiment of the present invention.

### DETAILED DISCRIPTION

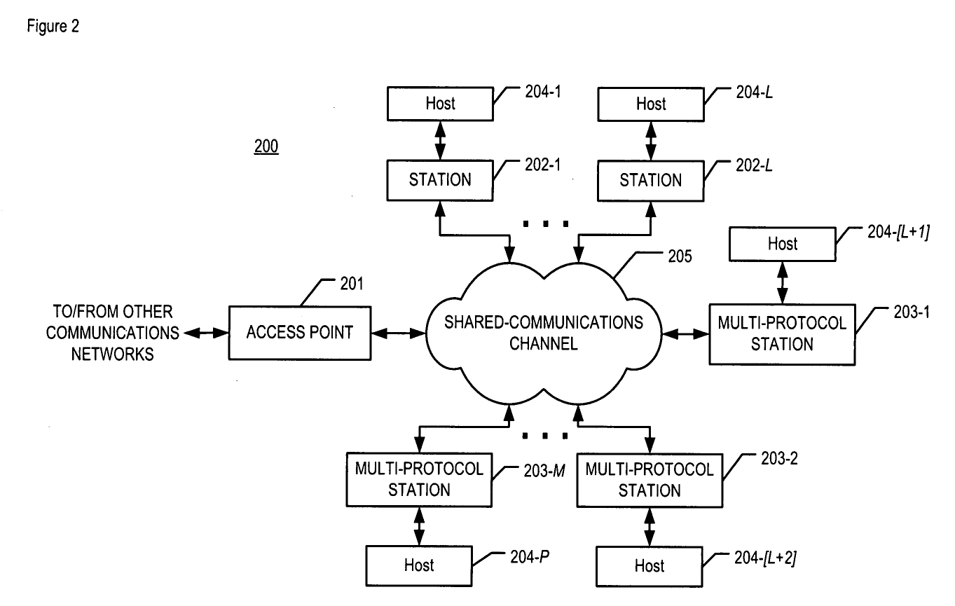

FIG. 2 depicts a schematic diagram of network 200 in accordance with the illustrative embodiment of the present invention. Network 200 comprises access point 201; stations 202-1 through 202-L, wherein L is a positive integer; multi-protocol stations 203-1 through 203-M, wherein M is a positive integer; host computers 204-1 through 202-P, wherein P is a positive integer equal to L plus M; and wireless shared-communications channel 205, interconnected as shown. In some embodiments, network 200 is a wireless local area network.

Access point 201, stations 202-1 through 202-L, and multi-protocol stations 203-1 through 203-M operate in accordance with an IEEE 802.11 standard. Multi-protocol stations 203-1 through 203-M also operate in accordance with the Bluetooth standard.

It will be clear to those skilled in the art, after reading this specification, how to make and use embodiments of the present invention that operate in accordance with other protocols. Furthermore, it will be clear to those skilled in the art, after reading this specification, how to make and use embodiments of the present invention that use a wireline or tangible shared-communications channel.

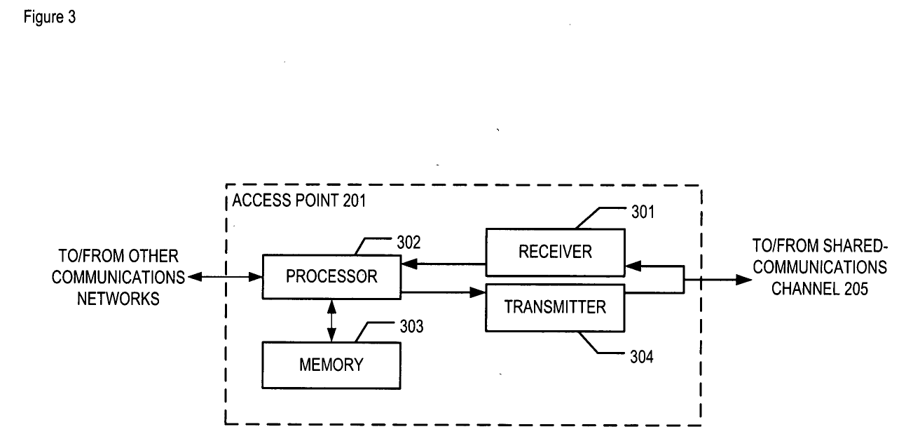

Access point 201 enables stations 202-1 through 202-L and multi-protocol stations 203-1 through 203-M within network 200 to communicate with devices in other communications networks. Furthermore, because access point 201 coordinates communication over shared-communications channel 205, stations 202-1 through 202-L and multi-protocol stations 203-1 through 203-M communicate with each other through access point 201. The salient details of access point 201 are described below and with respect to FIG. 3.

Stations within network 200, in other embodiments, communicate directly with each other and without access point 201. It will be clear to those skilled in the art how to make and use stations that communicate with each other without access point 201.

Station 202-i, for i=1 through L, comprises a radio that enables host computer 204-i to communicate via shared-communications channel 205 by using a single protocol only (i.e., IEEE 802.11 or Bluetooth, but not both). Station 202-i is capable of receiving data blocks from host computer 204-i and transmitting over shared-communications channel 205 messages (e.g., frames, packets, etc.) that comprise the data received from host computer 204-i. Station 202-i is also capable of receiving messages from shared-communications channel 205 and sending to host computer 204-i data blocks that comprise data from the messages. It will be clear to those skilled in the art how to make and use station 202-i.

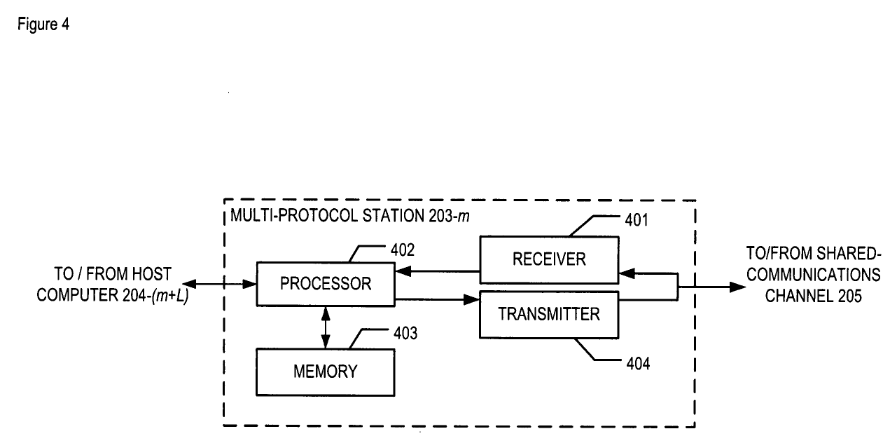

Multi-protocol station 203-m, for m=1 through M, comprises the radios that enable host computer 204-(m+L) to communicate via shared-communications channel 205. Multi-protocol station 203-m is capable of receiving data blocks from host computer 204-(m+L) and transmitting over shared-communications channel 205 data messages comprising the data received from host computer 204-(m+L). Multi-protocol station 203-m is also capable of receiving data messages from shared-communications channel 205 and sending to host computer 204-(m+L) data blocks comprising data from the data messages. It will be clear to those skilled in the art, after reading this specification, how to make and use multi-protocol station 203-m. The salient details for multi-protocol station 203-m are described below and with respect to FIG. 4.

Host computer 204-p, for p=1 to P, is capable of generating data blocks and transmitting those data blocks to station 202-p or multi-protocol station 203-j, wherein j is equal to (p−L). Host computer 204-p is also capable of receiving data blocks from station 202-p or multi-protocol station 203-j and of processing and using the data contained within those data blocks. Host computer 204-p can be, for example, a desktop or a laptop computer that uses network 200 to communicate with other hosts and devices via access point 201. It will be clear to those skilled in the art how to make and use host computer 204-p.

FIG. 3 depicts a block diagram of the salient components of access point 201 in accordance with the illustrative embodiment of the present invention. Access point 201 comprises receiver 301, processor 302, memory 303, and transmitter 304, interconnected as shown.

Receiver 301 is a circuit that is capable of receiving messages from shared-communications channel 205, in well-known fashion, and of forwarding them to processor 302. It will be clear to those skilled in the art how to make and use receiver 301.

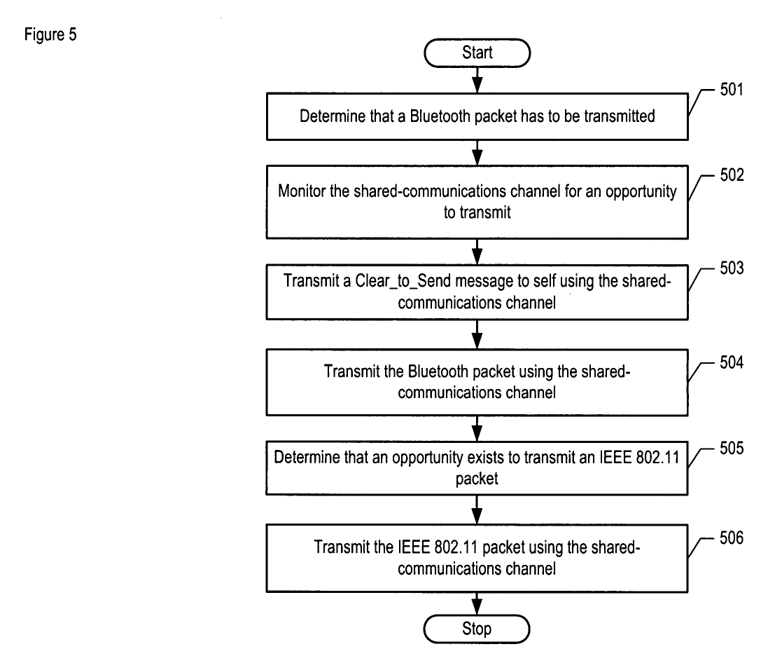

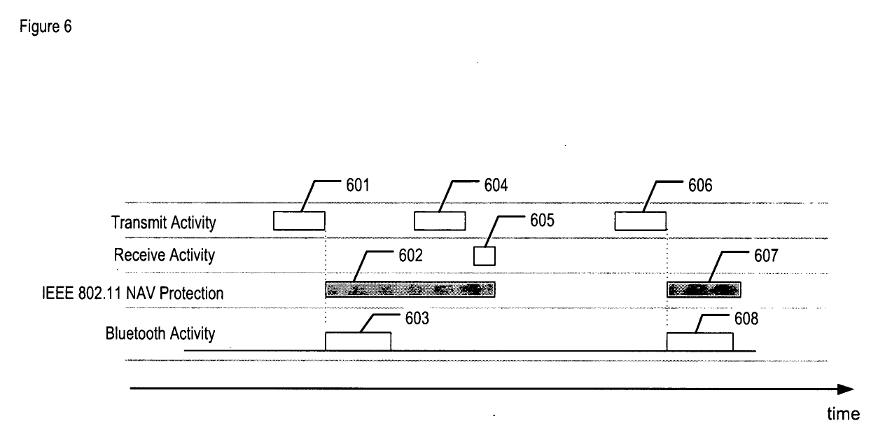

Processor 302 is a general-purpose processor that is capable of performing the tasks described below and with respect to FIGS. 5 and 6. It will be clear to those skilled in the art, after reading this specification, how to make and use processor 302.

Memory 303 is capable of storing programs and data used by processor 302. It will be clear to those skilled in the art how to make and use memory 303.

Transmitter 304 is a circuit that is capable of receiving messages from processor 302, in well-known fashion, and of transmitting them on shared-communications channel 205. It will be clear to those skilled in the art how to make and use transmitter 304.

FIG. 4 depicts a block diagram of the salient components of multi-protocol station 203-m in accordance with the illustrative embodiment of the present invention. Multi-protocol station 203-m comprises receiver 401-m, processor 402-m, memory 403-m, and transmitter 404-m, interconnected as shown.

Receiver 401-m is a circuit that is capable of receiving messages from shared-communications channel 205, in well-known fashion, and of forwarding them to processor 402-m. It will be clear to those skilled in the art how to make and use receiver 401-m.

Processor 402-m is a general-purpose processor that is capable of performing the tasks described below and with respect to FIGS. 5 and 6. It will be clear to those skilled in the art, after reading this specification, how to make and use processor 402-m.

Memory 403-m is capable of storing programs and data used by processor 402-m. It will be clear to those skilled in the art how to make and use memory 403-m.

Transmitter 404-m is a circuit that is capable of receiving messages from processor 402-m in well-known fashion, and of transmitting them on shared-communications channel 205. It will be clear to those skilled in the art how to make and use transmitter 404-m.

Multi-protocol station 203-m comprises a single receiver/transmitter pair, in accordance with the illustrative embodiment of the present invention. Receiver 401-m and transmitter 404-m are each capable of communicating in accordance with both the IEEE 802.11 protocol and the Bluetooth protocol. In other embodiments, multi-protocol station 203-m comprises multiple receiver/transmitter pairs, where each pair handles a specific protocol (e.g., IEEE 802.11, Bluetooth, etc.).

FIG. 5 depicts a flowchart of the salient tasks performed in accordance with the illustrative embodiment of the present invention. Multi-protocol station 203-1 is used as an example. For illustrative purposes, it is assumed that multi-protocol station 203-1 supports the IEEE 802.11 and Bluetooth protocols.

At task 501, multi-protocol station 203-1 determines that a Bluetooth packet is to be transmitted. This can be determined, for example, through packet traffic arbitration between IEEE 802.11 and Bluetooth medium access control, as is known in the art. It will be clear to those skilled in the art how to determine that a Bluetooth packet is to be transmitted.

At task 502, multi-protocol station 203-1 monitors shared-communications channel 205 in well-known fashion for an opportunity to transmit. For example, multi-protocol 203-1 can use carrier-sensing as a monitoring technique. It will be clear to those skilled in the art how to monitor shared-communications channel 205 for an opportunity to transmit.

At task 503, multi-protocol station 203-1 transmits a clear_to_send message to itself into shared-communications channel 205 and by using an IEEE 802.11 protocol. The clear_to_send message is a message not requiring a response that is used to convey a duration field and does not require a response. The duration field has a value based on the expected length of time required to transmit at least a first message (e.g., a Bluetooth packet, etc.) in accordance with the Bluetooth protocol. In some embodiments, the value of the duration field is also based on the expected length of time required to transmit at least a second message (e.g., an IEEE 802.11 frame, etc.) in accordance with the IEEE 802.11 protocol being used (e.g., 802.11a, 802.11b, 802.11g, etc.). The duration field is used by other stations within network 200 to update their network allocation vectors, as is known in the art. It will be clear to those skilled in the art how to transmit a clear_to_send message to self.

It will also be clear to those skilled in the art how to use a message other than clear_to_send to convey the duration field.

At task 504, multi-protocol station 203-1 transmits at least one Bluetooth message into shared-communications channel 205 in well-known fashion.

At task 505, in some embodiments, multi-protocol station 203-1 determines that an opportunity exists to transmit at least one IEEE 802.11 message. This can be determined, for example, through packet traffic arbitration, as is known in the art. In some embodiments, multi-protocol uses carrier-sensing on shared-communications channel 205, as part of determining an opportunity. It will be clear to those skilled in the art how to determine that an opportunity exists to transmit.

At task 506, in some embodiments, multi-protocol station 203-1 transmits at least one IEEE 802.11 message into shared-communications channel 205 in well-known fashion.

FIG. 6 depicts a sequence of messages (e.g., frames, packets, etc.) in accordance with the illustrative embodiment of the present invention. Multi-protocol station 203-1 is used as an example. For illustrative purposes, it is assumed that multi-protocol station 203-1 supports the IEEE 802.11 and Bluetooth protocols. In the example, the Bluetooth part of multi-protocol station 203-1 has to transmit High Quality Voice 3 (HV3) packets every 3.75 milliseconds with each packet being 625 microseconds in length. The IEEE 802.11 part of multi-protocol station 203-1 can be made aware of this transmission requirement in well-known fashion (e.g., through packet traffic arbitration, etc.).

Alternatively, the illustrative embodiment also supports the scenario in which the IEEE 802.11 and the Bluetooth part are in separate stations that are able to exchange transmission requirements with each other, and have to coexist with other stations. It will be clear to those skilled in the art, after reading this specification, how to apply the illustrative embodiment to two different stations (versus a multi-protocol station) that operate in accordance with two different protocols.

At event 601, multi-protocol station 203-1 transmits, in well-known fashion, a message that indicates clear_to_send to itself on shared-communications channel 205 using a first protocol (e.g., IEEE 802.11, etc.). Multi-protocol station 203-1 specifies within the message a duration field value that is based on the expected length of time required to transmit at least one message in accordance with a second protocol (e.g., Bluetooth, etc.) on shared-communications channel 205. Network allocation vector (NAV) protection interval 602 represents the specified length of time. It will be clear to those skilled in the art how to define and use a network allocation vector.

In some embodiments, multi-protocol station 203-1 times the message that indicates clear_to_send to be sent immediately before a message using the second protocol has to be sent. It will be clear to those skilled in the art how to determine when a message using the second protocol has to be sent.

At event 603, multi-protocol station 203-1 transmits a message (e.g., an HV3[or “High Quality Voice 3”] packet, etc.) on shared-communications channel 205 using the second protocol.

Multi-protocol station 203-1 then monitors shared-communications channel 205 to determine if multi-protocol station 203-1 is permitted to transmit in accordance with the first protocol. Monitoring can be performed in a variety of ways. As one example, the first protocol part of multi-protocol station 203-1 coexists with a second (i.e., Bluetooth) protocol part and, as such, can receive status directly on the Bluetooth part's usage of shared-communications channel 205. As another example, the first protocol part of multi-protocol station 203-1 might also sense the activity on shared-communications channel 205. At event 604, multi-protocol station 203-1 transmits a message (e.g., a data frame, etc.) on shared-communications channel 205 using the first protocol. For example, multi-protocol station 203-1 transmits the message to access point 201.

At event 605, multi-protocol receives an acknowledgement transmitted by the station (e.g., access point 201, etc.) that received the message corresponding to event 604.

In other embodiments, the first protocol part of multi-protocol station 203-1 does not transmit any messages during the network allocation vector protection interval. At event 606, multi-protocol station 203-i transmits a message that indicates clear_to_send to itself on shared-communications channel 205 using the first protocol (e.g., IEEE 802.11, etc.). Multi-protocol station 203-1 specifies within the message a duration field value based on the expected length of time required to transmit at least one message in accordance with the second protocol (e.g., Bluetooth, etc.) on shared-communications channel 205. Network allocation vector (NAV) protection interval 607 represents the specified length of time.

In some embodiments, multi-protocol station 203-1 times the message that indicates clear_to_send to be sent immediately before a message using the second protocol has to be sent. It will be clear to those skilled in the art how to determine when a message using the second protocol has to be sent.

At event 608, multi-protocol station 203-1 operating in accordance with the second protocol transmits another message (e.g., an HV3 [or “High Quality Voice 3”] packet, etc.) on shared-communications channel 205 using the second protocol.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

1. A method comprising:
(a) monitoring a shared-communications channel for an opportunity to transmit; and
(b) transmitting a first message on said shared-communications channel in accordance with a first protocol, wherein:
(i) said first message is addressed to the sender of said first message; and
(ii) said first message comprises a duration field that comprises a value that is based on the expected length of time required to transmit at least a second message on said shared-communications channel in accordance with a second protocol.

2. The method of claim 1 further comprising (c) transmitting said second message in accordance with said second protocol on said shared-communications channel.

3. The method of claim 2 further comprising:
transmitting a third message in accordance with said first protocol on said shared-communications channel after transmitting said second message;
wherein the value of said duration field is also based on the expected length of time required to transmit said third message.

4. The method of claim 3 wherein said first protocol is an IEEE 802.11-based protocol and said second protocol is a Bluetooth-based protocol.

5. The method of claim 2 wherein said second message is a Bluetooth High Quality Voice 3 packet.

6. The method of claim 1 wherein said first message indicates clear to send.

7. The method of claim 1 further comprising determining when to transmit said first message, based on the need to transmit said second message in accordance with said second protocol.

8. An apparatus comprising:
(a) a receiver for monitoring a shared-communications channel for an opportunity to transmit; and
(b) a transmitter for transmitting a first message on said shared-communications channel in accordance with a first protocol, wherein:
(i) said first message is addressed to the sender of said first message; and
(ii) said first message comprises a duration field that comprises a value that is based on the expected length of time required to transmit at least a second message on said shared-communications channel in accordance with a second protocol.

9. The apparatus of claim 8 wherein said transmitter is also for transmitting said second message in accordance with said second protocol on said shared-communications channel.

10. The apparatus of claim 9 wherein said transmitter is also for transmitting a third message in accordance with said first protocol on said shared-communications channel after transmitting said second message, wherein the value of said duration field is also based on the expected length of time required to transmit said third message.

11. The apparatus of claim 10 wherein said first protocol is an IEEE 802.11-based protocol and said second protocol is a Bluetooth-based protocol.

12. The apparatus of claim 9 wherein said second message is a Bluetooth High Quality Voice 3 packet.

13. The apparatus of claim 8 wherein said first message indicates clear to send.

14. The apparatus of claim 8 further comprising a processor for determining when to transmit said first message, based on the need to transmit said second message in accordance with said second protocol.

15. A method comprising:
(a) transmitting a first message,that indicates clear to send in accordance with a first protocol on a shared-communications channel, wherein:
(i) said first message that indicates clear to send is addressed to the sender of said first message; and
(ii) said first message indicating clear to send comprises a duration field that has a value based on the expected length of time required to transmit at least:
(1) a second message in accordance with a second protocol; and
(2) a third message in accordance with said first protocol;
(b) determining that an opportunity exists to transmit said third message on said shared-communications channel; and
(c) transmitting said third message in accordance with said first protocol on said shared-communications channel.

16. The method of claim 15 further comprising transmitting said second message in accordance with said second protocol on said shared-communications channel before the determining that an opportunity exists to transmit said third message.

17. The method of claim 15 further comprising monitoring said shared-communications channel for an opportunity to transmit.

18. The method of claim 15 wherein said first protocol is an IEEE 802.11-based protocol and said second protocol is a Bluetooth-based protocol.

19. The method of claim 15 wherein said third message is a Bluetooth High Quality Voice 3 packet.

20. The method of claim 15 further comprising determining when to transmit said first message that indicates clear to send, based on the need to transmit said second message in accordance with said second protocol.
